(19) United States
(12) Patent Application Publication
(10) Pub. No.: US 2016/0108763 A1
(43) Pub. Date: Apr. 21, 2016

(54) RANKINE CYCLE POWER GENERATION SYSTEM WITH SC-CO2 WORKING FLUID AND INTEGRATED ABSORPTION REFRIGERATINO CHILLER

(71) Applicant: Umm Al-Qura University, Makkah (SA)

(72) Inventors: Abdullah Ali R. AlZahrani, Oshawa (CA); Ibrahim Dincer, Oshawa (CA)

(21) Appl. No.: 14/514,488

(22) Filed: Oct. 15, 2014

(51) Int. Cl. F01K 25/10; F01K 19/04; F03G 6/00; F01K 7/22

(52) U.S. Cl. CPC F01K 25/103; F01K 7/22; F01K 19/04; F03G 6/005

(57) ABSTRACT

A power generation system in which a Rankine condensation power cycle using supercritical CO₂ as the working fluid is integrated with an absorption refrigeration chiller wherein the refrigerant is a mixture of ammonia and water, and the refrigerant is circulated in heat exchange relationship with the working fluid in a refrigerant evaporator that is a condenser for the working fluid. Thermal energy for the power cycle is supplied by a concentrating solar power plant.

### FIELD OF THE INVENTION

This invention relates generally to power generation systems, and more particularly to a power generation system that uses supercritical carbon dioxide (SC-CO₂) as the working fluid in a Rankine condensation power cycle with an integrated heat driven absorption refrigeration system (ARS) to condense the SC-CO₂ without requiring an external cooling source.

### BACKGROUND ART

During the last decade there has been a growing interest in supercritical carbon dioxide (SC-CO₂) as a working fluid for the Brayton gas cycle. However, the use of SC-CO₂ as a working fluid in a condensation power cycle (Rankine cycle) has been a challenge because of the low critical temperature (31° C.) of the SC-CO₂, which makes it very difficult to be condensed in the absence of a source of cooling water or air with a temperature of about 10° C. Accordingly, this working fluid is rarely considered for a Rankine power cycle in spite of several advantages that CO₂ may offer.

US patent application serial number 2012/0102996 attempts to solve this problem by using a Rankine cycle integrated at the desorber with an absorption chiller. In this system the desorber uses the heat available in the cycle working fluid after using an internal recuperator. All illustrations of the system disclosed in this application use a cooler and depend on an external cooling means such as water or atmospheric air to enhance the power cycle cooling.

US patent application serial number 2012/0125002 discloses a Rankine cycle integrated with an organic Rankine cycle and an absorption chiller cycle. In this application, a two Rankine or binary cycle power generator and a sort of cascaded heat utilization is proposed.

In a paper by H. Yamaguchi et. al., entitled “Solar Energy Powered Rankine Cycle Using Supercritical CO₂”, published in 2006 in Applied Thermal Engineering 26 (2006) 2345-2354, the authors proposed using an ambient cooling system in two stages and direct heating through an evacuated solar collector.

Applicant is not aware of any prior system in which a Rankine power cycle with CO₂ as the working fluid uses a heat driven absorption refrigeration system (ARS) to condense the CO₂ at low temperatures, around −5° C., and that ensures continuous operation of the SC-CO₂ Rankine power cycle independently of any external cooling water or other cooling media to condense the CO₂.

It would be desirable to have a power generation system using a Rankine power cycle with SC-CO₂ as the working fluid, in which an absorption refrigeration system (ARS) is integrated with the power cycle to condense the SC-CO₂ without the need for an external low temperature cooling medium such as water or air.

### SUMMARY OF THE INVENTION

For supercritical carbon dioxide (SC-CO₂) to be used as a working fluid in a

Rankine cycle, a low temperature sink (around 15° C.) must be available. Satisfying this condition in many locations is almost impossible due to the variation in ambient temperature throughout the year. Applicant has developed an integrated cooling system derived from relatively low-grade thermal energy available in the system to continuously provide the cooling duties required by the power cycle, thus making the power cycle operation independent of environmental conditions and enabling the several benefits available through the use of SC-CO₂ as the working fluid.

More specifically, the present invention is a power generation system comprising a Rankine power cycle with SC-CO₂ as the working fluid, in which an absorption refrigeration system (ARS) condenses the SC-CO₂ at a low temperature of around −5° C. without the need for an external low temperature cooling medium such as water or air.

The power generation system of the invention comprises two main subsystems: (1) a supercritical carbon dioxide (SC-CO₂) Rankine power cycle; and (2) an integrated absorption refrigeration system (ARS). The SC-CO₂ power cycle utilizes the thermal energy supplied by an external heat source to generate power, and the absorption refrigeration system cools the SC-CO₂.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a schematic diagram of a supercritical carbon dioxide (SC-CO₂) Rankine power cycle with an integrated absorption refrigeration system (ARS) to form the power generation system of the invention.

FIG. 2 is a schematic representation of the integrated cycle implemented as a power block in a concentrating solar power plant (CSP).

FIG. 3 is a diagram of the supercritical carbon dioxide cycle.

FIG. 4 is a schematic representation of the ammonia/water absorption system used in a preferred embodiment of the invention.

FIG. 5 is a plot of the changes in the energy and exergy efficiencies for the combined SC-CO₂ Rankine power cycle and the absorption refrigeration system with changes in the condenser/evaporator temperature.

FIG. 6 is a plot of the variations in the SC-CO₂ Rankine power cycle energy and exergy efficiencies with changes in the maximum cycle pressure.

FIG. 7 is a plot of the variations in the energy and exergy efficiencies of the SC-CO₂ Rankine power cycle with changes in the maximum cycle temperatures.

FIG. 8 is a plot of the change in the energy and exergy coefficients of performance (COPs) with changes in the heat source temperature.

FIG. 9 is a plot of the effects of varying the pinch temperature of the energy and exergy COPs.

### DETAILED DESCRIPTION OF THE PREFERRED EMBODIMENTS

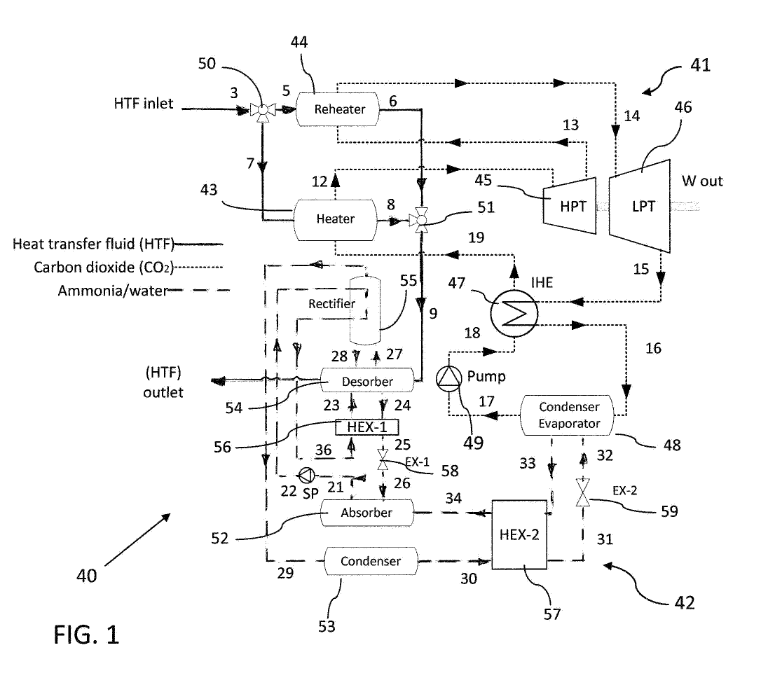

As shown in FIG. 1 the power generation system 40 of the invention is an integrated cycle that has two main subsystems: (1) a supercritical carbon dioxide (SC-CO₂) Rankine power cycle 41; and (2) an absorption refrigeration system (ARS) 42 integrated with the power cycle. The SC-CO₂ power cycle 41 utilizes the thermal energy supplied by an external heat source (not shown in FIG. 1) to generate power, and the ARS cools the SC-CO₂.

The supercritical carbon dioxide (SC-CO₂) Rankine power cycle 41 has seven components: heater 43, reheater 44, a two stage turbine comprising high pressure turbine 45 and low pressure turbine 46, an internal heat exchanger 47, condenser 48, which is integrated with the cooling system 42, and a working fluid pump 49.

Heat transfer fluid enters the system at 3 and is split by a diverter valve 50 into two streams 5 and 7 for supply to the heater 43 and reheater 44, respectively. The two streams 6 and 8 leaving the heater and reheater, respectively, are combined at valve 51 into a single stream 9 that is fed through a desorber in the absorption refrigeration loop as described hereinafter.

The working fluid circulation loop of the Rankine condensation power cycle 41 comprises the heater 43 through which the heat transfer fluid and CO₂ are circulated in heat exchange relationship to heat the CO₂ to its supercritical temperature and pressure at first state 12. The high pressure turbine 45 is connected to receive the supercritical CO₂ from the heater 43, and the CO₂ expands in the high pressure turbine to a lower temperature and pressure at second state 13. The reheater 44 is connected to receive the second state CO₂ from the high pressure turbine and heat it to a third state 14. The low pressure turbine 46 is connected to receive the CO₂ from the reheater and expand the CO₂ to a fourth state 15. The internal heat exchanger 47 is connected to receive the fourth state CO₂ from the low pressure turbine and through which the fourth state CO₂ passes and gives up some of its heat to leave the internal heat exchanger at a fifth state 16. Condenser 48 is connected to receive the CO₂ from the internal heat exchanger and through which the fifth state CO₂ passes and is condensed to a liquid sixth state 17. The working fluid pump 49 pumps the liquid CO₂ back through the internal heat exchanger and to the heater 43 to repeat the cycle.

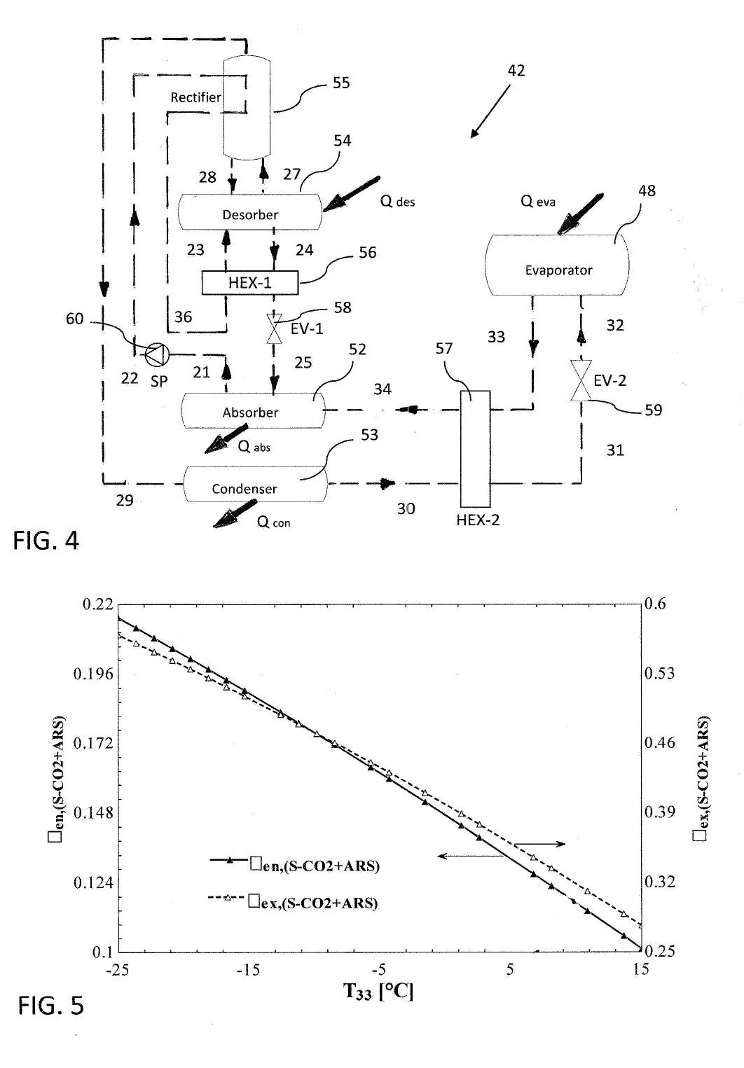

The absorption refrigeration system (ARS) 42, shown in FIG. 4 without the power cycle 41, operates on a single-stage ammonia/water absorption cycle and is integrated with the power cycle 41 at the condenser/evaporator 48. It is configured to generate a cooling effect in the evaporator 48 (the condenser of the S-CO₂ Rankine cycle) by utilizing a portion of the heat remaining in the heat transfer fluid after it leaves the heater 43 at state 8, as explained hereinafter.

The ammonia/water absorption refrigeration circulation loop has ten components: the evaporator 48 (the condenser of the power cycle), an absorber 52, a condenser 53, a desorber 54, a rectifier 55, two heat exchangers 56 and 57, two expansion valves 58 and 59, and a solution circulation pump 60 (see FIG. 4). The working fluid of the absorption system is a mixture of ammonia/water (NH₃/H₂O), where the refrigerant is the ammonia. The performance of the ARS is evaluated by determining energetic and exergetic coefficients of performance (COPs) of the system, as described more fully hereinafter.

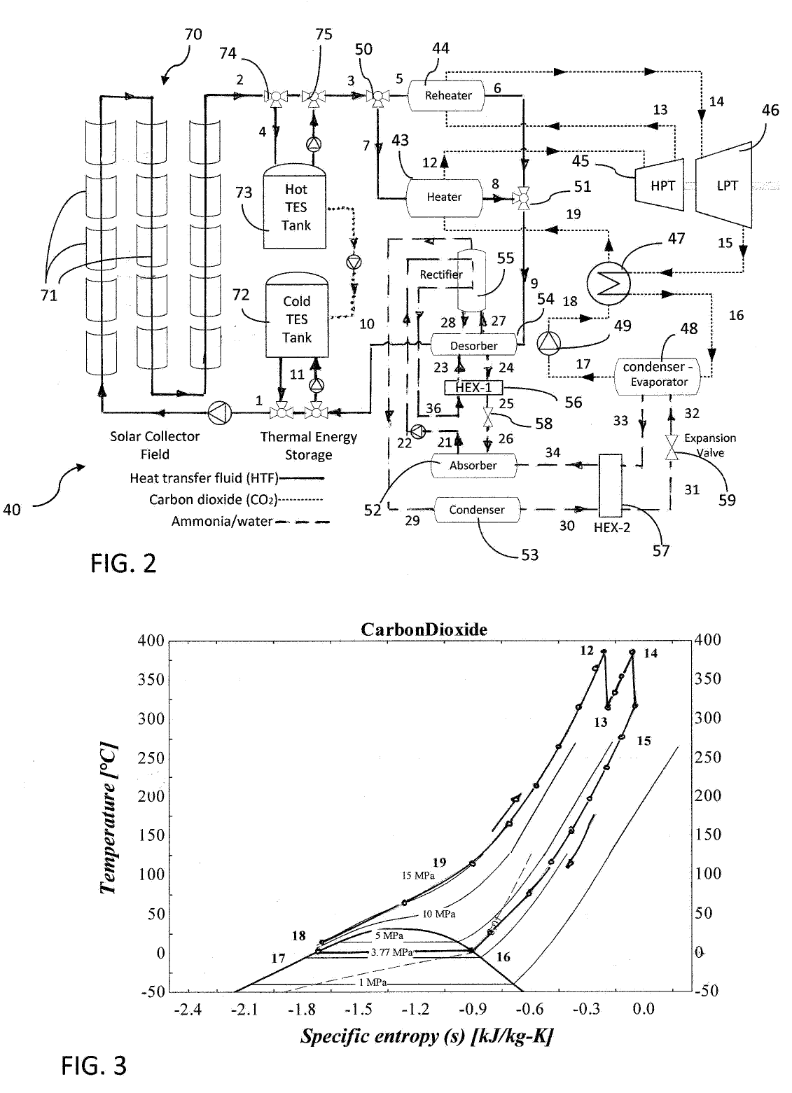

First, gaseous CO₂ leaves the internal heat exchanger 47 at state point 19 and enters the heater 43, where it is heated to a high temperature (about 390° C.) by the heat transfer fluid (HTF) coming from the external heat source (the solar field 70 in the preferred example shown in FIG. 2). Next, the CO₂ expands in the high pressure turbine (HPT) 45 from state 12 pressure of about 15 MPa to state 13 pressure of about 7.5 MPa. The CO₂ is then heated in the reheater 44 to state 14 of 390° C. and supplied to the low pressure turbine 46. After the heat transfer fluid is used to heat the carbon dioxide in the heater and reheater for power production in the turbines, the two streams exit the heater 43 and reheater 44 at points 8 and 6, respectively, and combine at state 9 with a temperature of 247° C. This temperature is high enough to be used in the desorber 54 to drive the absorption cycle whose refrigeration effect will be used for condensing the CO₂ in the Rankine power cycle.

The CO₂ expands in the low pressure turbine (LPT) 46 from state 14 to the pressure condenser level (about 3.77 MPa) at state point 15. Since the temperature of CO₂ gas at state 15 is still high enough to be utilized, it is sent to the internal heat exchanger 47 to recycle its heat in a regenerative process before being sent to the condenser/evaporator 48. The CO₂ is expected to leave the internal heat exchanger 47 at state 16 with a temperature of 22° C. and subsequently enter the condenser/evaporator 48 where the CO₂ will undergo a refrigeration process and eventually is condensed to leave the condenser/evaporator as a liquid state 17 with a temperature of 3° C. At this stage, the liquid phase is easy to pump to the heater pressure level at state 18 with a reasonable power input to pump 49. The liquid CO₂ is pumped to the internal heat exchanger 47 to be heated to state 19 by the hot stream coming from the low pressure turbine 46, and the cycle can then be repeated.

The operating principle of the power cycle 41 is based on an arrangement wherein heat is transferred to the system through a hot fluid (heat transfer fluid). In the heater 43 this heat is used to heat the CO₂. The high temperature and pressure CO₂ gas partially expands in the high pressure turbine 45 and is then sent to the reheater 44 to be heated and sent to the second stage turbine (low pressure turbine) 46 where CO₂ gas expands to the condenser pressure. In order to increase the system efficiency, the available heat in the CO₂ gas leaving the low pressure turbine is recovered through the internal heat exchanger 47 used to heat liquid CO₂ coming from the feed pump 49. CO₂ from the low pressure turbine leaves the internal heat exchanger at state 16 with a low temperature and is fed to the condenser 48 in which the CO₂ is fully condensed and pumped back through the internal heat exchanger 47, increasing the pressure of the CO₂ to the cycle's high pressure level. The pumped liquid goes through a transcritical phase change during the heating processes.

The operating principle of the absorption refrigeration system (ARS) 42 is as follows. The low grade heat available in the HTF streams 8 and 6 leaving the heater 43 and the reheater 44, respectively, is combined at valve 51 into a single stream 9 and further exploited by using it in the desorber 54 to condition the refrigerant to produce the required cooling effect in the power cycle condenser 48 to condense the CO₂. Before returning to the external heat source (not shown in FIG. 1), the heat transfer fluid at state 9 enters the desorber 54 and this heat is used to heat a mixture of ammonia (NH₃) and water in the desorber, where the ammonia evaporates and is fed at state 27 to rectifier 55 to increase the ammonia concentration and return evaporated water at state 28 to the desorber 54. The vaporized ammonia at state 29 is then fed from the rectifier to the condenser 53, rejecting its heat and leaving the condenser in a liquid state 30. The liquid state ammonia enters heat exchanger 57 where it is heated, and from heat exchanger 57 the ammonia at state 31 goes through the expansion valve 59, where its pressure drops from state 31 to state 32, and enters the evaporator 48 where it absorbs heat rejected by the power cycle and leaves the evaporator fully vaporized at state 33. It is then passed back through the heat exchanger 57 and enters the absorber 52 at state 34 where almost pure ammonia vapor is mixed with water. The refrigerant is circulated between the desorber 54 and absorber 52 in a circulation process in which liquid ammonia/water rich solution at state 21 is pumped through the rectifier 55 to the desorber 54. The refrigerant is subjected to two heating processes in the rectifier 55 and the solution heat exchanger 56. The high temperature solution leaves the desorber at state 24 and is fed through the solution heat exchanger 56 and through the solution expansion valve 58 to return to the absorber 52 at state 26, completing the solution circulation at the absorber 52.

In a preferred embodiment, the cycle is used as a power block in a concentrating solar power (CSP) plant and the overall plant is analyzed thermodynamically to assess its performance energetically and exegetically.

Use of a solar collector field 70 as the external heat source in the preferred embodiment is shown in FIG. 2, wherein a plurality of solar collectors 71 are connected in circuit with a cold thermal energy storage tank 72, a hot thermal energy storage tank 73, and valves 74, 75 and pumps for controlling flow of heat transfer fluid within the circuit and to and from the power cycle 41 and cooling system 42.

In operation, heat transfer fluid heated in the solar collectors is pumped through valves 74, 75 and 50 to the heater 43 and reheater 44 to heat the CO₂ as discussed above. After passing through the desorber 53 the heat transfer fluid is returned to the solar collector field 70 to be reheated by solar energy. Heat transfer fluid with a reduced temperature as it leaves the power cycle circulation loop is returned to the solar collector field to be reheated. Some or all of the cooled heat transfer fluid can be diverted and pumped into the cold thermal energy storage tank 72 for eventual return to the solar collector field. Similarly, the heat transfer fluid heated by the solar collector field may be diverted by valve 74 into the hot thermal energy storage tank 73 to eventually be pumped through valves 75 and 50 into the power generation circulation loop.

The following discussion analyzes the performance of the integrated systems under different operating conditions. The mass, energy, and exergy balance equations are written for each component, and subsequently the energy losses, exergy destruction, and the energy and exergy efficiencies are evaluated.

The general forms of the mass, energy, and exergy balance equations over a control volume, enclosing involved components, are presented in the following under steady state conditions with neglected potential and kinetic energy changes.

Σ\dot{m}ᵢ=Σ\dot{m}ₑ (1)

\dot{Q}−\dot{W}=Σ\dot{m}ₑhₑ−Σ\dot{m}ᵢhᵢ (2)

Ėx_{Q}−\dot{W}=Σ\dot{m}ₑexₑ−Σ\dot{m}ᵢexᵢ+Ėx_{D} (3)

where Ėx_{Q} represents the net exergy transfer associated with the heat \dot{Q} transferred to/from the component at temperature T, which is calculated as

Ėx_{Q}=Σ(1−Tₐ/T)\dot{Q} (4)

The specific exergy at point k is given by

exₖ=hₖ−hₐ−Tₐ(sₖ−sₐ) (5)

and Ė^{k} is the exergy rate at point k given by

Ėxₖ=\dot{m} exₖ=\dot{m}[hₖ−hₐ−Tₐ(sₖ−sₐ)] (6)

The analysis of the system is conducted by solving the system's model under the assumption listed in Table 1. The software Engineering Equation Solver (EES), Klein, S. A., Engineering Equation Solver (EES) for Microsoft Windows Operating System; Academic Commercial Version, 2002, F-Chart Software: Madison, was used to model and obtain the properties of the different working fluids used in the system.

TABLE 1
Main Assumptions from the SC-CO₂ Rankine Power Cycle

| Parameter | Value/Specification |
|---|---|
| T₁₂ (° C.) | 384 |
| Turbines isentropic efficiencies (%) | 85 |
| Pump isentropic efficiency (%) | 70 |
| IHE effectiveness (%) | 100 |
| T_{P} (° C.) | 8 |
| T₁₇ (° C.) | 3 |
| P₁₃ (MPa) | (P₁₂ * P₁₃)^{1/2} |
| P₁₂ (MPa) | 15 |

The heat transfer fluid used in the invention is Therminol-PV 1. Properties of this fluid can be found in Therminol®, Therminol VP-1 Vapor, Phase/Liquid Phase, Heat Transfer Fluid, [cited 2013; Available from http://www.therminol.com/pages/products/vp-1.asp. The mass flow rates, temperature and specific exergy of the HTF cycle are presented in Table 2 using the numbering system of FIG. 2.

TABLE 2
The State Points of the HTF cycle

| State | | m | Cₚ | T | ex |
|---|---|---|---|---|---|
| point | Fluid | (kg/s) | (kJ/kg-K) | (° C.) | (kJ/kg) |
| 0 | Therminol-PV1 | — | 1.559 | 25 | 0 |
| 1 | Therminol-PV1 | 8.691 | 1.664 | 60 | 3.396 |
| 2 | Therminol-PV1 | 8.691 | 2.611 | 395 | 338.1 |
| 3 | Therminol-PV1 | 8.691 | 2.611 | 390 | 330.9 |
| 4 | Therminol-PV1 | 0 | 2.611 | 390 | 330.9 |
| 5 | Therminol-PV1 | 4.156 | 2.611 | 390 | 330.9 |
| 6 | Therminol-PV1 | 4.156 | 2.418 | 338.1 | 239.7 |
| 7 | Therminol-PV1 | 4.535 | 2.611 | 390 | 330.9 |
| 8 | Therminol-PV1 | 4.535 | 1.896 | 143.9 | 35.89 |
| 9 | Therminol-PV1 | 8.691 | 2.157 | 247.2 | 121.3 |
| 10 | Therminol-PV1 | 8.691 | 1.664 | 60 | 3.396 |

The state point data of the SC-CO₂ cycle are listed in Table 3. The table presents mass flow rate, temperature, pressure, specific exergy, specific enthalpy, quality, and specific entropy for each point.

TABLE 3
The State Points Data for the SC-CO₂ Rankine Power Cycle

| | | m | T | P | ex | h | | s |
|---|---|---|---|---|---|---|---|---|
| State point | Fluid | (kg/s) | (° C.) | (MPa) | (kJ/kg) | (kJ/kg) | x (—) | (kJ/kg-K) |
| 0 | CO₂ | — | 25 | 0.1011 | 0 | −0.9365 | — | −0.00183 |
| 12 | CO₂ | 9.402 | 382 | 15 | 392.9 | 328.8 | 1 | −0.2136 |
| 13 | CO₂ | 9.402 | 330.1 | 9 | 337.8 | 278.2 | 1 | −0.1987 |
| 14 | CO₂ | 9.402 | 382 | 9 | 369.3 | 338.1 | 1 | −0.1034 |
| 15 | CO₂ | 9.402 | 298.8 | 3.77 | 277.9 | 254.4 | 1 | −0.07728 |
| 16 | CO₂ | 9.402 | 22.52 | 3.77 | 192.7 | −46.4 | 1 | −0.8007 |
| 17 | CO₂ | 9.402 | 3 | 3.77 | 211.8 | −299.3 | 0 | −1.713 |
| 18 | CO₂ | 9.402 | 14.52 | 15 | 223.7 | −282 | 1 | −1.695 |
| 19 | CO₂ | 9.402 | 135.9 | 15 | 261.3 | 18.8 | — | −0.8121 |

The main assumptions regarding the ARS that are made to facilitate the modeling listed as follows:
The condenser and absorber operating temperature is 35° C.
The evaporator at operate at −5° C.
The state points 28, 21, 30 and 24, according to the numbering system shown in FIG. 2, are taken as saturation liquid states.
The points 33, 29 and 27 are taken as saturation vapor states.
The refrigerant concentration at state point 29 is set as 0.99
The heat exchangers effectiveness is defined as

$$ɛ = \frac{{\dot{Q}}_{c}}{{\dot{Q}}_{h}} = 97 \%$$

where \dot{Q}ₕ, is the hot stream utility, and \dot{Q}_{c} is the cold stream utility.
The solution pump efficiency is taken as 65%.

The properties of the state points of the absorption refrigeration cycle are listed in Table 4. The working fluid, mass flow rate, temperature, pressure, specific exergy, specific enthalpy, quality, specific entropy and concentration are identified according to each point.

TABLE 5
State Points Data for the Absorption Refrigeration System

| | | | | | | | | s | |
|---|---|---|---|---|---|---|---|---|---|
| State | | m | T | P | ex | h | | (kJ/kg- | |
| point | Fluid | (kg/s) | (° C.) | (kPa) | (kJ/kg) | (kJ/kg) | x (—) | K) | C (—) |
| 21 | NH₃/H₂O | 12.76 | 30 | 312.4 | 781.4 | −104.9 | 0 | 0.2966 | 0.4706 |
| 22 | NH₃/H₂O | 12.76 | 30.16 | 1167 | 782.5 | −103.4 | −0.01 | 0.298 | 0.4706 |
| 23 | NH₃/H₂O | 12.76 | 77.05 | 1167 | 805 | 135.8 | 0.02055 | 1.025 | 0.4706 |
| 24 | NH₃/H₂O | 10.73 | 94.64 | 1167 | 732.9 | 201.2 | 0 | 1.188 | 0.3706 |
| 25 | NH₃/H₂O | 10.73 | 38.12 | 1167 | 702.5 | −50.59 | −0.01 | 0.4453 | 0.3706 |
| 26 | NH₃/H₂O | 10.73 | 38.29 | 312.4 | 701.5 | −50.59 | −0.01 | 0.4485 | 0.3706 |
| 27 | NH₃/H₂O | 2.084 | 75.11 | 1167 | 1350 | 1433 | 1 | 4.714 | 0.9855 |
| 28 | NH₃/H₂O | 0.0555 | 73 | 1167 | 799.5 | 99.46 | 0 | 0.9215 | 0.4706 |
| 29 | NH₃ | 2.029 | 36 | 1167 | 1340 | 1296 | 1 | 4.295 | 0.999 |
| 30 | NH₃ | 2.029 | 30 | 1167 | 1317 | 141.5 | 0 | 0.5003 | 0.9996 |
| 31 | NH₃ | 2.029 | 19.49 | 1167 | 1317 | 91.07 | −0.01 | 0.3309 | 0.9996 |
| 32 | NH₃ | 2.029 | −8.21 | 312.4 | 1309 | 91.07 | 0.0994 | 0.3575 | 0.9996 |
| 33 | NH₃ | 2.029 | −5 | 312.4 | 1168 | 1263 | 0.997 | 4.762 | 0.9996 |
| 34 | NH₃ | 2.029 | 14.44 | 312.4 | 1165 | 1314 | 1.001 | 4.943 | 0.9996 |
| 36 | NH₃/H₂O | 12.76 | 36.34 | 1167 | 783.2 | −75.9 | −0.01 | 0.3878 | 0.4706 |

Plots of some of the performance results for the system of the invention are shown in FIGS. 3 and 5-9.

FIG. 5 is a plot of the changes in energy and exergy efficiencies against changes in the SC-CO₂ condenser temperature (the ARS evaporator temperature) for the combined SC-CO₂ Rankine power cycle and absorption refrigeration system. The energy efficiencies are varied linearly between 10% to 22% for the combined power and cooling system. The exergy efficiencies also varied in the same patterns, with higher figures, i.e. from 25% to 60%. A general observation from FIG. 5 is that the power cycle performs better at lower condenser temperatures because of the increase of the work that can be extracted by expanding to a lower pressure. For example, if the absorption refrigeration cycle had not been used and cooling water was available to achieve the condensation process at 15° C. (which is quite difficult for a year-round operation) the system will have an energy efficiency of 10% and exergy efficiency of 25%. However, the introduction of the ARS enables lower condensation temperature to be achieved and provides a stable cooling system independent of environmental conditions.

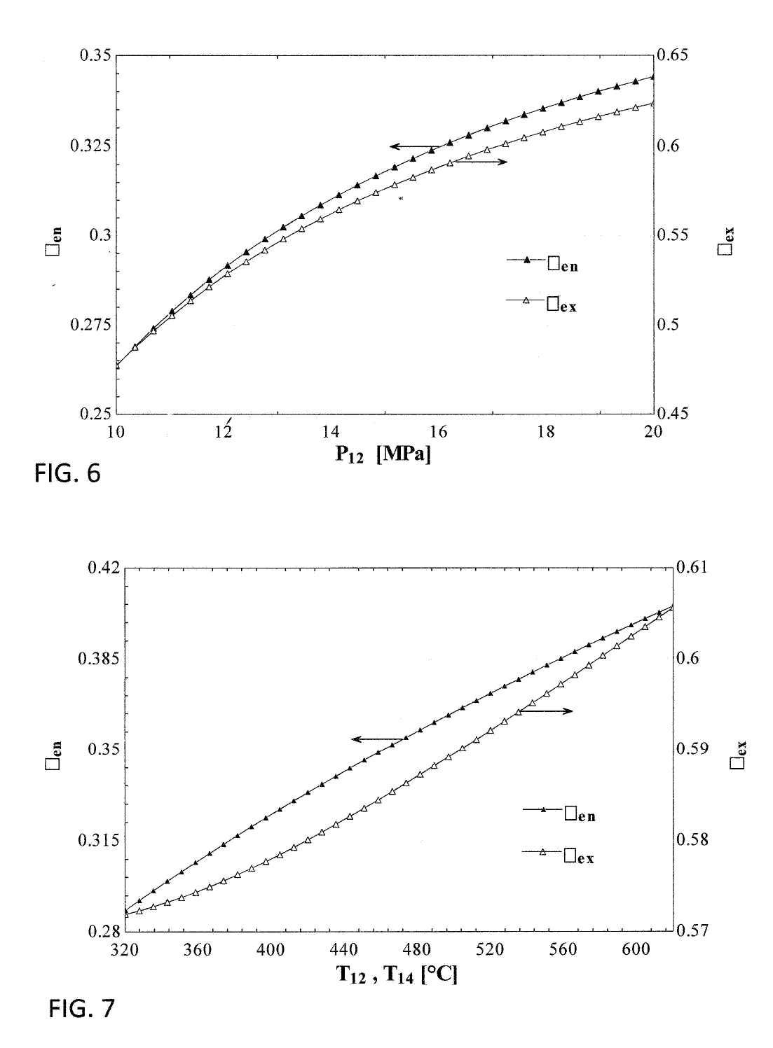

FIG. 6 shows the effects on the cycle energy and exergy caused by varying the maximum cycle pressure in the SC-CO₂ Rankine power cycle. It can be clearly seen that the increase in the cycle pressure has a positive impact on the cycle performance with respect to energy and exergy.

FIG. 7 shows the effects on the SC-CO₂ Rankine cycle energy and exergy efficiencies caused by varying the maximum cycle temperature (source temperature). The figure shows the high potential of the SC-CO₂ Rankine power cycle, especially for high temperature applications such as a solar tower. The cycle is expected to achieve energy and exergy efficiencies of 38.5% and 56.5%, respectively, when an inlet temperature to the turbines of 560° C. is achieved.

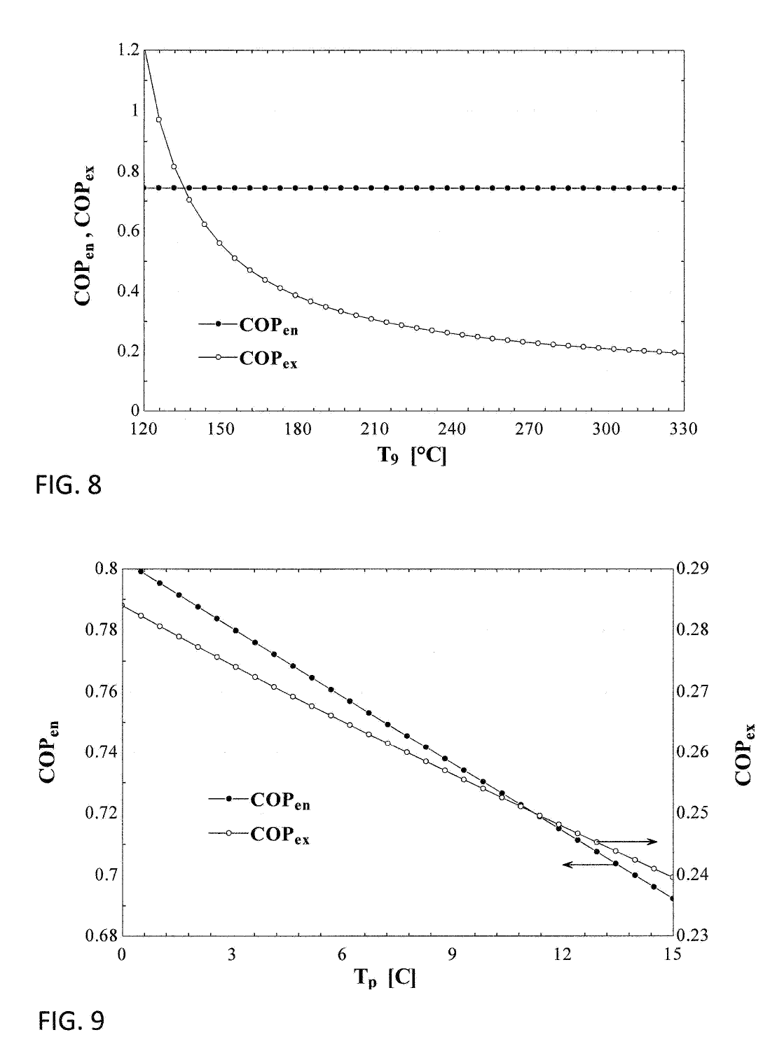

FIG. 8 shows the effects on the ARS performance of changing the heat source temperature, while maintaining the heat duties constant. It can be observed that the energy coefficient of performance (COP) remains constant over the entire range, while the exergy COP shows a dramatic change. This is because of the limitation of the energy analysis since it only considers the quantities rather than the quality. However, the exergy analysis clearly shows the preferable operating condition since it considers both energy quantity and energy quality as the second law of thermodynamics implies. FIG. 8 represents one of the great advantages of exergy analysis for systems design. The increase in the exergy COP, with a decrease in the heat source temperature as shown in FIG. 8, is due to the reduction in the exergy destruction when operating at lower temperatures. Thereby, the exergy COP suggests using a lower temperature energy source to increase the exergy performance of the ARS unit and for best utilization of that energy source.

FIG. 9 shows the effects on the energy and exergy COPs of the ARS caused by changing the assumed pinch point, (Tₚ), for the different heat exchanging elements. The ARS can achieve as high as 0.76 in energy COP, and 0.265 in exergy COP, by employing heat exchangers with a pinch point temperature of 6°. However, with a higher pinch point temperature of 15°, the energy and exergy COPs will decrease to about 0.685 and 0.24, respectively.

The advantages of using CO₂ as a working fluid according to the invention are apparent from the foregoing and include the following.
First, with CO₂ as the working fluid, the SC-CO₂ Rankine power cycle has the potential to achieve a higher conversion efficiency compared to the conventional Rankine cycle (steam cycle).
Second, because of the lower density of CO₂, especially at higher temperatures compared with steam, for example, the use of CO₂ is expected to result in a considerable reduction in cycle equipment size compared to conventional systems.
Third, the reduction in the equipment size will result in a reduction in plant area size, and most important, a reduction in capital cost.
Fourth, the heating process of the CO₂ takes a supercritical path (process from point 18 to point 12 in FIG. 3) which results in a better match in the heat exchangers with the hot utility and subsequently a better heat transfer process.
Fifth, the CO₂ is categorized as a “dry fluid” in terms of the fluid quality leaving the turbine, and this makes the reheat and multi-staging turbine possible without the risk of moisture formation.
Sixth, the SC-CO₂ Rankine cycle's condenser is expected to operate well above atmospheric pressure, whereby the risks of vacuum loss and atmospheric air penetration are eliminated.
Seventh, CO₂ is chemically stable for cyclic operation, nontoxic, and abundant in nature.
Eighth, CO₂ in liquid, gas and/or supercritical fluid is not corrosive to metal and alloys.

The advantages of using the absorption refrigeration system (ARS) in the invention are apparent from the foregoing description and include the following.
The ARS makes the SC-CO₂ Rankine cycle practical.
The ARS offers lower condensation pressure for the SC-CO₂ Rankine cycle.
The ARS provides continuous cooling independent of external cooling sources such as water and ambient temperature.
The ARS enables utilization of low grade heat (about 120-250° C.) and increases the plant exergetic efficiency.
The ARS is perfect for concentrated solar power (CSP) plants, most of which are in locations that have higher solar potential and are in areas with limited water resources.

Assessment of the cycle performance of the invention was implemented in a solar system (CSP) and analyzed energetically and energetically. The performances of the cycle as well as the ARS were evaluated simultaneously under different operating conditions. The main conclusions from this study are summarized in the following points:
The SC-CO₂ Rankine power cycle is expected to achieve energy and exergy efficiencies of 31.6%, and 57.5%, respectively. Under the same operating conditions, the energy and exergy COPs of the ARS are found to be about 0.7 and 0.27, respectively.
The integration of ARS with the SC-CO2 Rankine power cycle is very promising, particularly for concentrating solar power plant applications.
The reheat Rankine cycle demonstrates good performance with the use of SC-CO2 as the working fluid.
The use of ARS as a cooling system can ensure continuous design point performance independent of external water resources temperature or weather changes.
Further development of this system has a potential to achieve higher energy conversion efficiency, reduce equipment size, plant area, and capital cost

While particular embodiments of the invention have been illustrated and described in detail herein, it should be understood that various changes and modifications may be made in the invention without departing from the spirit and intent of the invention as defined by the appended claims.

What is claimed is:

1. A power generation system comprising:
a Rankine condensation power cycle using supercritical CO₂ as a working fluid, wherein thermal energy for the power cycle is provided by an externally supplied heat transfer fluid, said power cycle having a working fluid circulation loop comprising:
a heater through which the heat transfer fluid and CO₂ are circulated in heat exchange relationship to heat the CO₂ to a supercritical temperature and pressure first state;
a high pressure turbine connected to receive the supercritical CO₂ which expands in the high pressure turbine to a lower temperature and pressure second state;
a reheater connected to receive the second state CO₂ and heat it to a third state;
a low pressure turbine connected to receive the CO₂ from the reheater and expand the CO₂ to a fourth state;
an internal heat exchanger connected to receive the fourth state CO₂ from the low pressure turbine and through which the fourth state CO₂ passes and gives up some of its heat to leave the internal heat exchanger at a fifth state;
a working fluid condenser connected to receive the CO₂ from the internal heat exchanger and through which the fifth state CO₂ passes and is condensed to a liquid sixth state; and
a working fluid pump for pumping the liquid CO₂ back through the internal heat exchanger and to the heater to repeat the cycle; and
a heat driven absorption refrigeration cycle integrated with the power cycle at the condenser of the working fluid circulation loop to provide cooling duties required by the power cycle to condense the CO₂, wherein the refrigeration cycle has a refrigerant circulation loop comprising:
a desorber through which the refrigerant is circulated in heat exchange relationship with the heat transfer fluid from the heater and reheater in the working fluid circulation loop to use the relatively low-grade thermal energy in the heat exchange fluid to vaporize the refrigerant;
a refrigerant condenser connected to receive and condense the vaporized refrigerant; and
an evaporator connected to receive the condensed refrigerant and through which the refrigerant is circulated in heat exchange relationship with the working fluid to evaporate the refrigerant and take up heat from the working fluid and condense the working fluid, said evaporator comprising the condenser in the working fluid circulation loop.

2. The power generation system as claimed in claim 1, wherein:
the refrigerant is a solution of ammonia and water;
a rectifier is connected to receive the vaporized refrigerant from the desorber to increase the concentration of ammonia before the refrigerant is passed to the condenser;
an expansion valve is connected between the condenser and the evaporator and in which the refrigerant is expanded; and
a heat exchanger is connected between the refrigerant condenser and the expansion valve to increase the temperature of the refrigerant before it enters the evaporator.

3. The power generation system as claimed in claim 2, wherein:
an absorber is connected in the refrigerant circulation loop to receive refrigerant circulating from the evaporator back through the heat exchanger.

4. The power generation system as claimed in claim 3, wherein:
a second heat exchanger is connected in the refrigerant circulation loop between the desorber and the absorber.

5. The power generation system as claimed in claim 4, wherein:
an expansion valve is connected in the refrigerant circulation loop between the second heat exchanger and the absorber.

6. The power generation system as claimed in claim 5, wherein:
a refrigerant solution pump is connected in the refrigerant circulation loop to pump the solution of ammonia and water from the absorber to and through the rectifier and second heat exchanger and to the desorber.

7. The power generation system as claimed in claim 6, wherein:
the refrigerant circulation loop connects the rectifier to the desorber to return evaporated water from the rectifier to the desorber.

8. The power generation system as claimed in claim 7, wherein:
a solar collector field heats the heat transfer fluid, said solar collector field being connected to supply the heat transfer fluid to the heater and reheater of the working fluid circulation loop.

9. The power generation system as claimed in claim 8, wherein:
the heat transfer fluid that passes through the heater and reheater is combined into a single stream and fed through the desorber to recover the heat still available in the heat transfer fluid.

10. The power generation system as claimed in claim 1, wherein:
a solar collector field heats the heat transfer fluid, said solar collector field being connected to supply the heat transfer fluid to the heater and reheater of the working fluid circulation loop.

11. The power generation system as claimed in claim 10, wherein:
a valve receives the heat transfer fluid that passes through the heater and reheater to combine the heat transfer fluid into a single stream, said desorber being connected to receive the single stream of heat transfer fluid and feed it to the desorber to recover the heat still available in the heat transfer fluid.

12. A power generation system comprising:
a Rankine condensation power cycle using supercritical CO₂ as a working fluid, wherein thermal energy for the power cycle is supplied by a concentrating solar power plant, said power cycle having a working fluid circulation loop comprising:
a heater through which the heat transfer fluid is circulated in heat exchange relationship with CO₂ to heat the CO₂ to SC-CO₂;
work producing means through which the SC-CO₂ expands to produce a work output;
a working fluid condenser for receiving the expanded SC-CO₂ from the work producing means and condensing the SC-CO₂ to a liquid state; and
a pump for pumping the condensed SC-CO₂ back to the heater to repeat the cycle; and
an absorption refrigeration system integrated with the power cycle to chill the working fluid in the condenser, said absorption refrigeration system having a refrigerant circulation loop comprising:
a desorber through which the refrigerant is circulated in heat exchange relationship with the heat transfer fluid to vaporize the refrigerant; and
a refrigerant condenser for condensing the vaporized refrigerant, said condenser in the working fluid circulation loop connected to receive the condensed refrigerant, where the refrigerant expands and takes up heat in the working fluid to condense the working fluid to a liquid state.

13. The power generation system as claimed in claim 12, wherein:
said work producing means comprises a dual stage turbine including a high pressure turbine and a low pressure turbine.

14. The power generation system as claimed in claim 13, wherein:
said working fluid circulation loop comprises said heater, said two stage turbine, said working fluid condenser, said pump, a reheater, and an internal heat exchanger.

15. The power generation system as claimed in claim 14, wherein:
said refrigerant circulation loop comprises said desorber, said refrigerant condenser, a refrigerant evaporator that is the condenser of the working fluid circulation loop, an absorber, a rectifier, two heat exchangers, two expansion valves, and a solution circulation pump, wherein the refrigerant is a mixture of ammonia/water (NH₃/H₂O), said ammonia being the refrigerant.

16. The power generation system as claimed in claim 15, wherein:
a solar collector field heats the heat transfer fluid, said solar collector field being connected to supply the heat transfer fluid to the heater and reheater of the working fluid circulation loop.

17. A power generation system, comprising:
a Rankine condensation power cycle using supercritical CO₂ as the working fluid, wherein the power cycle has a working fluid circulation loop that includes a condenser in which the working fluid is condensed; and
an absorption refrigeration chiller having a refrigerant circulation loop integrated with the working fluid circulation loop at said working fluid condenser, wherein said refrigerant is evaporated and takes up heat from the working fluid to condense it.
